(19) United States
(12) Patent Application Publication
(10) Pub. No.: US 2011/0105780 A1
(43) Pub. Date: May 5, 2011

(54) Method for obtaining polysulphide monoorganoxysilanes

(75) Inventors: Nathalie Guennouni, Irigny (FR); Virginie Pevere, Lyon (FR); Bernard Vogin, Chaponost (FR)

(73) Assignee: RHODIA CHIMIE, BOULOGNE BILLANCOURT (FR)

(21) Appl. No.: 10/497,933

(22) PCT Filed: Dec. 6, 2002
(86) PCT No.: PCT/FR02/04204

§ 371 Date: Nov. 18, 2004

(30) Foreign Application Priority Data
Dec. 6, 2001 (FR) 01/15768
Aug. 9, 2002 (FR) 02/10145

(51) Int. Cl. C07F 7/04

(52) U.S. Cl. 556/427

(57) ABSTRACT

The invention concerns the preparation of sulphur-containing organosilicic compounds of general formula (I) wherein, for example: R¹═C₁-C₁₅ alkyl; R² and R³═C₁-C₆ alkyl; in a mean number ranging from 1.5±0.1 to 5±0.1. Said preparation is carried out by performing successively the following steps (a), (b) and (c): (a) hydrosilylation of the type: R²R³HSi-Hal+CH₂═CH—CH₂-Hal}Hal-R²R³Si—(CH₂)₃Hal; (b) alcoholysis of the type: Hal-R²R³Si—(CH2)3-Hal+R¹—OH}R′O—R²R³Si—(CH₂)₃Hal; (c) sulphidization of the type: R′O—R²R³Si—(CH₂)₃Hal+M₂Sₓ} compound of formula (I); with Hal=a halogen atom and M=alkali metal.

The present invention relates to a novel route for the synthesis of polysulfide monoorganoxysilanes which is carried out from starting materials which are products available on the industrial scale, without formation of harmful secondary products and virtually quantitative yields from the various constituent stages of this novel synthetic route.

More specifically, it is a process for the preparation of sulfur-comprising organosilicon compounds corresponding to the general formula:

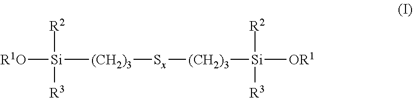

in which:
the R¹ symbols, which are identical or different, each represent a monovalent hydrocarbonaceous group chosen from a linear or branched alkyl radical having from 1 to 15 carbon atoms and a linear or branched alkoxyalkyl radical having from 2 to 8 carbon atoms;
the R² and R³ symbols, which are identical or different, each represent a monovalent hydrocarbonaceous group chosen from a linear or branched alkyl radical having from 1 to 6 carbon atoms and a phenyl radical; and
x is an integer or fractional number ranging from 1.5±0.1 to 5±0.1.

In the preceding formula (I), the preferred R¹ radicals are chosen from the radicals: methyl, ethyl, n-propyl, isopropyl, n-butyl, CH₃OCH₂—, CH₃OCH₂CH₂— and CH₃OCH(CH₃)CH₂—; more preferably, the R¹ radicals are chosen from the radicals: methyl, ethyl, n-propyl and isopropyl.

The preferred R² and R³ radicals are chosen from the radicals: methyl, ethyl, n-propyl, isopropyl, n-butyl, n-hexyl and phenyl; more preferably, the R² and R³ radicals are methyls.

The integer or fractional number x preferably ranges from 3±0.1 to 5±0.1 and more preferably from 3.5±0.1 to 4.5±0.1.

The polysulfide monoorganoxysilanes corresponding to the formula (I) which are especially targeted by the present invention are those of formula:

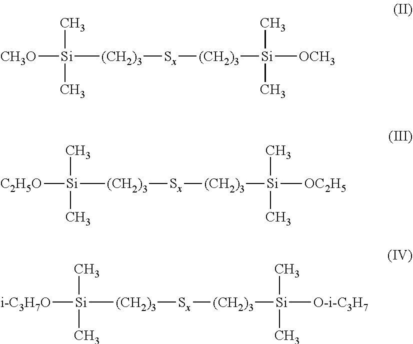

in which the x symbol is an integer or fractional number ranging from 1.5±0.1 to 5±0.1, preferably from 3±0.1 to 5±0.1 and more preferably from 3.5±0.1 to 4.5±0.1.

In the present report, it will be specified that the symbol x in the formulae (I), (II), (III) and (IV) is an integer or fractional number which represents the number of sulfur atoms present in a molecule of formula (I), (II), (III) and (IV).

In practice, this number is the mean of the number of sulfur atoms per molecule of compound under consideration, insofar as the chosen synthetic route gives rise to a mixture of polysulfide products each having a different number of sulfur atoms. The polysulfide monoorganoxysilanes synthesized are in fact composed of a distributipn of polysulfides, ranging from the monosulfide to heavier polysulfides (such as, for example, Sₙ), centered on a mean value in moles (value of the x symbol) lying within the general range (x ranging from 1.5±0.1 to 5±0.1), preferable range (x ranging from 3±0.1 to 5±0.1) and more preferable range (x ranging from 3.5±0.1 to 4.5±0.1) which are mentioned above.

It is known that it is possible to prepare bis(trialkoxysilylalkyl)polysulfides from the corresponding trialkoxysilylalkyl halides by four general polysulfiding processes:
the first comprises the reaction of trialkoxysilyl-alkyl halides with the reaction product of ammonia NH₃ or a primary or secondary amine with H₂S and elemental sulfur, the reaction being carried out under autogenous pressure at a temperature ranging from 0° C. to 175° C., optionally in the presence of an inert polar (or nonpolar) organic solvent (cf. in particular U.S. Pat. No. 4,125,552);
the second comprises the reaction of a mixture based on elemental sulfur and on trialkoxysilylalkyl halide with the reaction product of H₂S with a solution of a metal alkoxide, the reaction being carried out at a temperature ranging from 25° C. to the reflux temperature of the reaction medium (cf. in particular U.S. Pat. No. 5,489,701);
the third comprises the reaction of trialkoxysilyl-alkyl halides with anhydrous alkali metal polysulfides, the reaction being carried out at a temperature ranging from 40° C. to the boiling point of the mixture, optionally in the presence of an inert polar (or nonpolar) organic solvent (cf. in particular U.S. Pat. No. 5,859,275);
the fourth comprises the reaction of trialkoxysilyl-alkyl halides with elemental sulfur and an alkali metal, the reaction being carried out at a temperature ranging from 60° C. to 100° C., optionally in the presence of an aprotic organic solvent (cf. in particular U.S. Pat. No. 6,066,752).

For their part, the trialkoxysilylalkyl halides are obtained by alcoholysis in the usual way from the corresponding trihalosilylalkyl halides.

It should be noted that, in the abovementioned documents of the prior art, no specific information is found relating to the preparation of bis(monoalkoxy-silylalkyl)polysulfides. It should also be noted that the abovementioned documents give no information relating to the preparation of halosilylalkyl halides in general, which are the precursor compounds subjected to the abovementioned alcoholysis reaction. In point of fact, the production of these starting materials (halosilylalkyl halides) is an important stage of such a nature as to determine the economic advantage of the overall synthetic route resulting in the preparation of the bis(trialkoxysilylalkyl)polysulfides and in particular in that of the bis(monoorganoxysilylalkyl)polysulfides of formula (I) which are targeted in the present invention.

It is one of the essential aims of the present invention to provide a novel high-performance synthetic route for access to bis(monoorganoxysilylalkyl polysulfides):
because it employs precursor monohalosilylalkyl halides possessing an industrial accessibility and a price which are highly advantageous with regard to industrial profitability,
because it comprises a sequence of stages which will take place virtually quantitatively, this being the case in particular for the polysulfidation stage, without resorting to reactants and/or without formation of secondary products which are toxic compounds or compounds which pollute the environment (such as H₂S and alkali metals, in the case of the polysulfidation stage).

The process according to the present invention, for the preparation of polysulfide monoorganoxysilanes [or bis(monoorganoxysilylpropyl)polysulfide] of formula (I), is characterized in that it consists in linking together the following stages (a), (b) and (c):
stage (a), which takes place according to the equation:

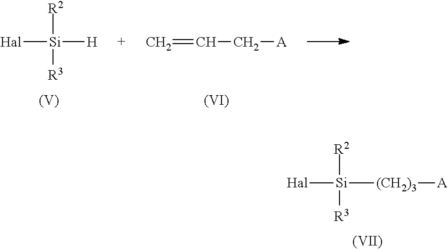

where:
the Hal symbol represents a halogen atom chosen from chlorine, bromine and iodine atoms, the chlorine atom being preferred,
the R² and R³ symbols are as defined above,
A represents a removable group chosen from: either a halogen atom Hal belonging to the chlorine, bromine and iodine atoms, the chlorine atom being preferred; or a para-R⁰—C₆H₄—SO₂—O— radical where R⁰ is a linear or branched C₁-C₄ alkyl radical, the tosylate radical para-CH₃-C₆H₄—SO₂—O— being preferred; or an R⁰—SO₂—O—radical where R⁰ is as defined above, the mesylate radical CH₃—SO₂—O— being preferred; or an R⁰—CO—O— radical where R⁰ is as defined above, the acetate radical CH₃—CO—O— being preferred,
the reaction is carried out:
   by reacting, at a temperature ranging from −10° C. to 200° C., one mol of the diorganohalosilane of formula (V) with a stoichiometric molar amount or a molar amount different from stoichiometry of the allyl derivative of formula (VI), the reaction being carried out in a homogeneous or heterogeneous medium in the presence of an initiator consisting:
      either of a catalytic activator consisting of: (i) at least one catalyst comprising at least one transition metal or one derivative of said metal taken from the group formed by Co, Ru, Rh, Pd, Ir and Pt; and optionally (2i) at least one hydrosilylation reaction promoter,
      or of a photochemical activator consisting in particular of appropriate ultraviolet radiation or of appropriate ionizing radiation,
   and optionally by isolating the diorganohalosilylpropyl derivative of formula (VII) formed;
stage (b), which takes place according to the equation:

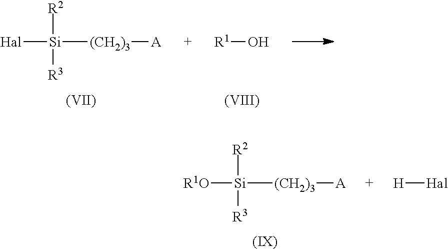

where:
the R¹, R², R³, Hal and A symbols are as defined above,
the reaction is carried out:
   by reacting, at a temperature ranging from −20° C. to 200° C., either the reaction medium obtained on conclusion of stage (a) or the diorganohalosilylpropyl derivative of formula (VII), taken in isolation after separation from said medium, with the alcohol of formula (VIII) using at least one mol of alcohol of formula (VIII) per mole of the reactant of formula (VII), the reaction optionally being carried out in the presence of a base and/or of an organic solvent,
   and optionally by isolating the monoorganoxydiorganosilylpropyl derivative of formula (IX) formed;
stage (c), which takes place according to the equation:

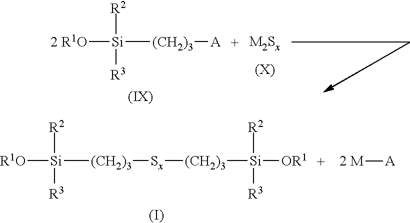

where:
the R¹, R², R³, A and x symbols are as defined above,
the M symbol represents an alkali metal,
the reaction is carried out:
   by reacting, at a temperature ranging from 20° C. to 120° C., either the reaction medium obtained on conclusion of stage (b) or the monoorganoxydiorganosilylpropyl derivative of formula (IX), taken in isolation after separation from said medium, with the metal polysulfide of formula (X) in the anhydrous state using 0.5±25% mol and preferably 0.5±15% mol of metal polysulfide of formula (X) per mole of the reactant of formula (IX), the reaction optionally being carried out in the presence of an inert polar (or nonpolar) organic solvent,
   and by isolating the bis(monoorganoxysilylpropyl)polysulfide of formula (I) formed.

The process according to the present invention makes it possible to industrially access bis(monoorganoxysilylpropyl)polysulfides of formula (I) starting from diorganohalosilanes of formula (V), in particular from (CH₃)₂HSiCl. These diorganohalosilanes of formula (V) can advantageously be prepared on the industrial scale by a process such as, in particular, that disclosed in WO-A-99/31111.

It would not be departing from the scope of the present invention to replace stages (a) and (b) by the following stages (a′) and (b′):
stage (a′), which takes place according to the equation:

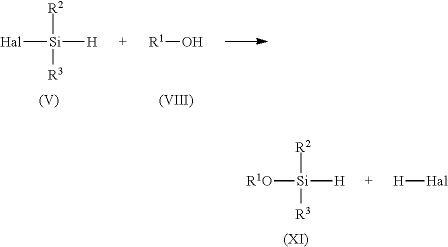

where:
the Hal, R², R³ and R¹ symbols are as defined above,
the reaction is carried out:
   by reacting, at a temperature ranging from −20° C. to 200° C., one mol of the diorganohalosilane of formula (V) with at least one mol of alcohol of formula (VIII), the reaction optionally being carried out in the presence of a base and/or of an organic solvent,
   and optionally by isolating the monoorganoxydiorganosilane of formula (XI) formed;
stage (b′), which takes place according to the equation:

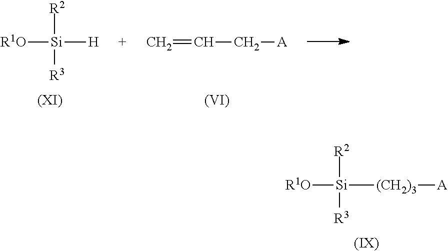

where:
the R¹, R², R³ and A symbols are as defined above,
the reaction is carried out:
   by reacting either the reaction medium obtained on conclusion of stage (a′) or the monoorganoxydiorganosilane of formula (XI), taken in isolation after separation from said medium, using one mol of silane of formula (XI), with a stoichiometric molar amount or a molar amount different from stoichiometry of the allyl derivative of formula (VI), the reaction being carried out in a homogeneous or heterogeneous medium in the presence of an initiator consisting:
      either of a catalytic activator consisting of: (i) at least one catalyst comprising at least one transition metal or one derivative of said metal taken from the group formed by Co, Ru, Rh, Pd, Ir and Pt; and optionally (2i) at least one hydrosilylation reaction promoter,
      or of a photochemical activator consisting in particular of appropriate ultraviolet radiation or of appropriate ionizing radiation,
   and optionally by isolating the monoorganoxydiorganosilylpropyl derivative of formula (IX) formed.

It should be understood that stage (c) according to the process of the invention can be carried out, as indicated above, starting from, in addition to the reaction medium obtained on conclusion of stage (b), the reaction medium obtained on conclusion of stage (b′) explained above.

According to a particularly suitable embodiment of the invention, the process which has just been described consists in linking together either stages (a), (b) and (c) or stages (a′), (b′) and (c), in the definition of which the removable group A corresponds to the Hal symbol representing a halogen atom chosen from chlorine, bromine and iodine atoms and preferably a chlorine atom.

Stage (a) consists in reacting the diorganohalosilane of formula (V) with the allyl derivative of formula (VI) in the presence of the chosen initiator. Stage (b′) consists, for its part, in reacting the monoorganoxydiorganosilane of formula (XI) with the allyl derivative of formula (VI) also in the presence of this chosen initiator.

The initiator which is used comprises all the initiators, corresponding to the types indicated above, which are effective in activating the reaction between an ≡SiH functional group and an ethylenic unsaturation.

According to a preferred provision relating to the initiator, the latter is chosen from catalytic activators. These catalytic activators comprise:
as the catalyst(s) (i): (i-1) at least one finely divided elemental transition metal; and/or (i-2) a colloid of at least one transition metal; and/or (i-3) an oxide of at least one transition metal; and/or (i-4) a salt derived from at least one transition metal and from an inorganic or carboxylic acid; and/or (i-5) a complex of at least one transition metal equipped with halogenated and/or organic ligand(s) which can have one or more heteroatom(s) and/or with organosilicon ligand(s); and/or (i-6) a salt as defined above where the metal part is equipped with ligand(s) also as defined above; and/or (i-7) a metal entity chosen from the abovementioned entities (elemental transition metal, oxide, salt, complex, complexed salt) where the transition metal is combined this time with at least one other metal chosen from the family of the elements from Groups Ib, IIb, IIIa, IIIb, IVa, IVb, Va, Vb, VIb, VIIb and VIII (except Co, Ru, Rh, Pd, Ir and Pt) of the Periodic Table as published in “Handbook of Chemistry and Physics, 65th edition, 1984-1985, CRC Press Inc.”, said other metal being taken in its elemental form or in a molecular form, it being possible for said combination to give rise to a bimetallic or polymetallic entity; and/or (i-8) a metal entity chosen from the abovementioned entities (elemental transition metal and transition metal-other metal combination; oxide, salt, complex and complexed salt on a transition metal base or on a transition metal-other metal combination base) which is supported on an inert solid support (inert with respect to the reaction carried out), such as, for example, alumina, silica, carbon black, a clay, titanium oxide, an aluminosilicate, a mixture of aluminum and zirconium oxides, or a polymer resin; and/or (i-9) a supported metal entity corresponding to the definition given above in section (i-8), in the structure of which the inert solid support itself carries at least one halogenated and/or organic ligand which can include one or more heteroatom(s);
as the optional promoter(s) (2i): a compound which can have, for example, the form of a ligand or of an ionic compound taken in particular from the group formed by: an organic peroxide; a carboxylic acid; a carboxylic acid salt; a tertiary phosphine; a phosphite, such as, for example, an optionally mixed alky and/or aryl phosphite; an amine; an amide; a linear or cyclic ketone; a trialkylhydrosilane; benzotriazole; phenothiazine; a compound of trivalent metal-(C₆H₅)₃ type where metal=As, Sb or P; a mixture of amine or of cyclohexanone with an organo-silicon compound comprising one or more ≡Si—H group(s); the compounds CH₂═CH—CH₂—OH or CH₂═CH—CH₂—OCOCH₃; a lactone; a mixture of cyclohexanone with triphenylphosphine; or an ionic compound, such as, for example, an alkali metal or imidazolinium nitrate or borate, a phosphonium halide, a quaternary ammonium halide or a tin(II) halide.

The optional promoter(s) (2i), when one (or more) of them is (are) used, is(are) generally introduced at the beginning of the reaction, either in the state in which it(they) is(are) normally found or in the form of a premix based on: promoter(s)+catalyst(s) (i); or promoter(s)+all or part of the diorganohalosilane of formula (V); or promoter(s)+all or part of the allyl derivative of formula (VI).

According to a more preferred provision relating to the initiator, the latter is chosen from the preferred catalytic activators mentioned above which comprise, as the catalyst(s) (i), one and/or other of the metal entities (i-1) to (i-9) where the transition metal belongs to the following subgroup: Ir and Pt.

According to an even more preferred provision relating to the initiator, the latter is chosen from the preferred catalytic activators mentioned above which comprise, as the catalyst(s) (i), one and/or other of the metal entities (i-1) to (i-9) where the transition metal is Ir. In the context of this even more preferred provision, catalysts based on Ir which are suitable are in particular:
[IrCl(CO)(PPh₃)₂]
[Ir(CO)H(PPh₃)₃]
[Ir (C₈H₁₂)(C₅H₅N)P(C₆H₁₁)₃]PF₆
[IrCl₃].nH₂O
H₂[IrCl₆].nH₂O
(NH₄)₂IrCl₆
Na₂IrCl₆
K₂IrCl₆
Klr(NO)Cl₅
[Ir (C₈H₁₂)₂]⁺BF₄⁻
[IrCl(CO)₃]ₙ
H₂IrCl₆
Ir₄(CO)₁₂
Ir(CO)₂(CH₃COCHCOCH₃)
Ir(CH₃COCHCOCH₃)
IrBr₃
IrCl₃
IrCl₄
IrO₂
(C₆H₇)(C₆H₁₂)Ir.

In the context of the even more preferred provision mentioned above, other catalysts based on Ir which are even more suitable are taken from the group of the iridium complexes of formula:

[Ir(R⁴)Hal]₂ (XII)
where:
the R⁴ symbol represents an unsaturated hydrocarbonaceous ligand comprising at least one C═C double bond and/or at least one C≡C triple bond; it being possible for these unsaturated bonds to be conjugated or nonconjugated, said ligand being linear or cyclic (mono- or polycyclic), having from 4 to 30 carbon atoms, having from 1 to 8 ethylenic and/or acetylenic unsaturations and optionally comprising one or more heteroatoms, such as, for example, an oxygen atom,and/or a silicon atom;
the Hal symbol is as defined above.

Mention will be made, as examples of iridium complexes of formula (XII) which are even more suitable, of those in the formula of which:
the R⁴ symbol is chosen from 1,3-butadiene, 1,3-hexadiene, 1,3-cyclohexadiene, 1,3-cyclo-octadiene, 1,5-cyclooctadiene, 1,5,9-cyclo-dodecatriene and norbornadiene, and the following compounds of formulae:

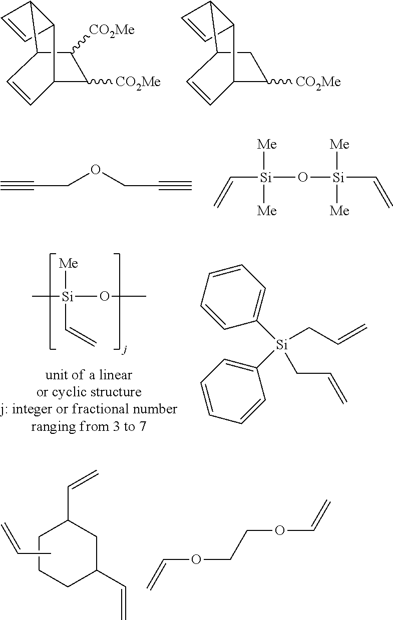

the Hal symbol represents a chlorine atom.

Mention will be made, as specific examples of iridium complexes which are even more suitable, of the following catalysts:
di-μ-chloro-bis(divinyltetramethyldisiloxane)diiridium,
di-μ-chloro-bis(η-1,5-hexadiene)diiridium,
di-μ-bromo-bis(η-1,5-hexadiene)diiridium,
di-μ-iodo-bis(η-1,5-hexadiene)diiridium,
di-μ-chloro-bis(η-1,5-cyclooctadiene)diiridium,
di-μ-bromo-bis(η-1,5-cyclooctadiene)diiridium,
di-μ-iodo-bis(η-1,5-cyclooctadiene)diiridium,
di-μ-chloro-bis(η-2,5-norbornadiene)diiridium,
di-μ-bromo-bis(η-2,5-norbornadiene)diiridium,
di-μ-iodo-bis(η-2,5-norbornadiene)diiridium.

The catalyst can be used, and this is another preferred provision, in a homogeneous medium as disclosed in JP-B-2 938 731. In this context, the reaction can be carried out either continuously or semicontinuously or batchwise. At the end of the operation, the reaction product is separated and collected by distillation of the reaction medium and it is possible to recycle the catalyst by adding a fresh charge of reactants to a distillation residue comprising the catalyst resulting from the stage of distillation of the product from the preceding operation, with optional supplementary addition of fresh catalyst. In the case of the use of complexes, the recycling of the catalyst can be improved by also adding a small amount of ligand.

The catalyst can also be used in a heterogeneous medium. This procedure involves in particular the use of a catalyst which is supported on an inert solid support of the type of those defined above. This procedure makes it possible to carry out the reaction in a stationary bed reactor operating continuously, semicontinuously or batchwise with recycling. It is also possible to carry out the reaction in a standard stirred reactor operating continuously, semi-continuously or batchwise.

Returning to the preferred case where the catalyst is used in the homogeneous medium, it is possible in this context, as specified above, to recover the metal from the catalyst present in the liquid distillation residue obtained, for the purpose of recycling it.

At the end of the operation, the reaction product is thus separated and collected by distilling the reaction medium and it is possible to recover the catalytic metal present in the liquid distillation residue, said metal being in its original form of catalyst or in a converted form. According to a highly suitable method, the liquid distillation residue is brought into contact with an effective adsorbent amount of a solid adsorbing agent. The solid adsorbent is generally provided in the form of powder, of an extrudate or of a granule or grafted to a support, such as cellulose, for example.

The use is more especially recommended, as solid adsorbent, of carbon black; active charcoals; molecular sieves, which are generally metal aluminosilicates, silicalites or synthetic zeolites; silicas; activated aluminas; adsorbent fillers based on diatomite and on perlite; activated and milled clays based on bentonite and on attapulgite; ion-exchange resins; or resins of amberlite or amberlyst type.

Adsorption can be carried out batchwise, with compounds of powder type, or continuously, via a column or through a stationary bed. The contact time can vary from 5 minutes to 10 hours, preferably between 30 minutes and 7 hours under batchwise conditions. The temperature can vary from 5 to 150° C., preferably from 10 to 30° C.

The amount of adsorbent used for active charcoals, molecular sieves, silicas, aluminas and inorganic adjuvants is closely related, first, to the specific adsorption capacity relating to each of the adsorbents which it is possible to use in the context of the invention and, secondly, to the operating parameters, such as the temperature and the presence or absence of a solvent.

The adsorption capacity (q) is expressed as the number of moles of metal adsorbed per kilogram of adsorbent used. This amount q is generally between 0.1 and 30, preferably between 0.5 and 20. In the case where the adsorbent is an ion-exchange resin, the resin is characterized by an exchange capacity value which is specific for each grade of resin and which is related to the functional group carried by this resin. This exchange capacity is generally expressed in meq/g for a dry product or in meq/ml with regard to a wet product. These resins will preferably be used in such away that the molar ratio of the functional group carried by the resin to the metal present in the solution to be treated is between 1 and 30, preferably between 1 and 15 and more particularly between 1 and 5.

The adsorption stage can be carried out at atmospheric pressure or under reduced pressure and optionally in the presence of a solvent which is inert with respect to the hydrogen halide H-Hal present in trace amounts in the medium. The use is recommended of alkanes (preferably C₆ and C₇ alkanes) and of aromatic solvents (toluene, xylene or chlorobenzene).

The solid adsorbent at the surface of which the catalytic metal is adsorbed is separated from the distillation residue by any suitable liquid/solid separation means, such as filtration, centrifugation or sedimentation. The metal is subsequently separated from the adsorbent by any physicochemical means compatible with said adsorbent.

According to an alternative form which is more particularly well suited, the recovery process additionally comprises, after the stage (1) during which the reaction medium is distilled to separate the product formed from a liquid distillation residue comprising the byproducts and the catalytic metal or its derivatives, a stage (2) in which the liquid residue is brought into contact with water optionally in the presence of an organic solvent which is inert with respect to H-Hal formed, for the purposes of obtaining an aqueous phase and an organic phase and of hydrolyzing said residue. For reasons of ease of implementation and of efficiency of the treatment and in order to improve the safety of the recovery process, it is recommended to operate with a prehydrolyzed distillation residue and to subsequently subject it to the adsorption stage (3).

Hydrolysis can be carried out in an acidic or basic medium. If the reaction is carried out in acidic medium, the aqueous solution used as reactant can be preacidified (with H-Hal, for example) or can be composed solely of demineralized water. The pH of the solution then changes during the reaction in the direction of values below 7. In this case, it is possible to neutralize the aqueous phase at the end of hydrolysis by adding a base. Hydrolysis is preferably carried out in a basic medium so that all the H-Hal is removed. It is recommended to run the residue onto an aqueous solution heel. Hydrolysis can be carried out at temperatures of from −15° C. to 80° C. As the reaction is exothermic, it is preferable to run in the residue at moderate temperatures of between −10 and 30° C. Control of the temperature may prove to be necessary. The water used for the hydrolysis can be introduced in the form of ice or of an ice/salt mixture. After the residue has finished being run in, the medium obtained is a two-phase medium composed of an organic phase and an aqueous phase.

Preferably, the water is added in an amount sufficient for the H-Hal formed not to be at saturation in the aqueous phase.

As regards the other reaction conditions appropriate for stages (a) and (b′) of the process according to the present invention, the reaction is carried out within a broad temperature range preferably from −10° C. to 100° C. at atmospheric pressure or under a pressure of greater than atmospheric pressure which can reach or even exceed 20×10⁵ Pa.

The amount of the allyl derivative of formula (VI) used is preferably from 1 to 2 mol per 1 mol of organo-silicon compound. With regard to the amount of catalyst(s) (i), expressed as weight of transition metal taken from the group formed by Co, Ru, Rh, Pd, Ir and Pt, it lies within the range from 1 to 10 000 ppm, preferably from 10 to 2000 ppm and more preferably from 30 to 1000 ppm, based on the weight of organosilicon compound of formula (V) or (XI). The amount of promoter(s) (2i), when one or more of them is(are) used, expressed as number of moles of promoter(s) per gram atom of transition metal taken from the group formed by Co, Ru, Rh, Pd, Ir and Pt, lies within the range from 0.1 to 1000, preferably from 0.5 to 500 and more preferably from 1 to 300. The diorganohalosilylpropyl derivative of formula (VII) or the monoorganoxydiorganosilylpropyl derivative of formula (IX) is obtained with a molar yield at least equal to 80% based on the starting organosilicon compound of formula (V) or (XI).

Stage (b) consists in reacting the diorganohalosilylpropyl derivative of formula (VII) with the alcohol of formula (VIII). Stage (a′) consists in reacting the hydrosilane of formula (V) with the alcohol of formula (VIII).

In practice, each of these alkoxylation stages is carried out in a way known per se according to an alcoholysis process such as that disclosed, for example, in J. Amer. Chem. Soc., 3601 (1960).

The reaction can be carried out, and this is a first processing arrangement, in the presence of a base in order to neutralize the halogen acid formed. Various types of nonaqueous bases or organic bases can be used, in particular tertiary amines, such as, for example, trialkylamines; appropriate bases of this type are, for example, triethylamine, tributylamine or diisopropylethylamine. The base can be used either in stoichiometric amounts, or in excess, when its removal is subsequently easy to carry out, or in amounts which are less than stoichiometry. In this last case, the base used may advantageously make it possible to neutralize the residual amount of halogen acid formed present in the reaction medium and which would not have been able to be removed by the methods described below; in this specific context, use may be made, in addition to tertiary amines, of metal alkoxides derived from an alkali metal (such as, for example, sodium) and from a lower C₁-C₄ aliphatic alcohol (such as, for example, methanol or ethanol). The reaction can also be carried out in the presence of an organic solvent which can, for example, be a lower C₁-C₄ aliphatic alcohol and in particular the alcohol of formula (VIII) employed in carrying out the alcoholysis reaction.

The reaction can also be carried out, and this is a second processing arrangement, in the absence of a base. This second arrangement is preferred. In this case, the removal from the reaction medium of the halogen acid formed will be promoted by appropriate methods which consist of:
1k: degassing the halogen acid by heating the reaction medium at its boiling point,
2k: stripping the halogen acid using a dry inert gas, such as, for example, nitrogen,
3k: degassing by using an appropriate partial vacuum,
4k: removing the halogen acid formed by entrainment using an organic solvent, it being possible for this solvent advantageously to be the alcohol of formula (VIII) employed in excess in carrying out the reaction.

The reaction can optionally be carried out in an inert organic solvent of aprotic and not very polar type, such as aliphatic and/or aromatic hydrocarbons; solvents of this type which are suitable are linear or cyclic alkanes, such as, for example, pentane, hexane or cyclohexane, and aromatic hydrocarbons, such as, for example, toluene or xylenes.

As regards the other reaction conditions, the reaction is carried out within a broad temperature range preferably from 0° C. to 160° C. The molar ratio of alcohol of formula (VIII) to silicon compound of formula (VII) or silane of formula (V) preferably lies:
when the reaction is carried out in the presence of a base: within the range from 1 to 30 and preferably from 1 to 15,
when the reaction is carried out in the absence of a base: within the range from 1 to 30 and preferably from 1 to 25.

As indicated above, a processing arrangement which is preferred consists in carrying out the reaction in the absence of a base. In this preferred context, it is entirely advantageous to promote the removal of the halogen acid formed by using method 4k, also mentioned above.

When the reaction is preferably carried out in the absence of a base, the reaction temperature advantageously lies within a temperature range from 60° C. to 160° C. and the molar ratio of alcohol of formula (VIII) to silicon compound of formula (VII) or silane of formula (V) advantageously lies within the range from 3 to 23.

The expression “reaction temperature” is understood to define the boiling point of the reaction medium. This temperature depends on the composition of the medium and it is adjusted, in a way known per se, by the heating power contributed to the medium and by the flow rate of the alcohol of formula (VIII) entering the reaction medium.

The starting reaction medium, comprising all the ingredients except the alcohol of formula (VIII), can be preheated to a temperature lying within the range from 60° C. to 160° C. or to a higher temperature. When the alcohol of formula (VIII) is introduced, the medium is modified in its composition and the heating power is adjusted so that the temperature is in equilibrium at a value lying within the abovementioned temperature region which makes it possible, on the one hand, to bring the alcohol to the boil and, on the other hand, on removing this alcohol from the medium, to entrain the halogen acid formed. The flow rate and the period of time for introducing the alcohol of formula (VIII) are adjusted so as to make possible gradual removal of the halogen acid from the medium, thus allowing the reaction the time necessary for it to take place. For example, for a flow rate ranging from 100 to 600 grams/hour, the period of time for introducing the alcohol of formula (VIII) lies between 30 minutes and 10 hours.

According to a third processing arrangement which is more preferred, use is made of an alcohol of formula (VIII) in the anhydrous state, that is to say an alcohol with a water content of less than 1000 ppm and preferably lying in the range from 10 to 600 ppm.

According to a fourth processing arrangement which is very particularly well suited, the reaction is carried out in the absence of a base, at a temperature lying within the range from 60° C. to 160° C., using anhydrous alcohol including less than 1000 ppm of water and removing the halogen acid by application of method 4k, the molar ratio of alcohol of formula (VIII) to silicon compound of formula (VII) or silane of formula (V) lying within the range from 3 to 23.

It is possible, and this constitutes a fifth highly advantageous processing arrangement, to reuse, in all or part, the distilled mixture based on alcohol of formula (VIII) and on halogen acid in carrying out, batchwise, a subsequent operation. In other words, stage (b) or (a′) can be carried out without disadvantage using, as starting alcohol of formula (VIII), an alcohol reactant consisting in all or part of the distilled mixture based on alcohol of formula (VIII) and on halogen acid resulting from the batchwise implementation of a preceding operation, with optional supplementary addition of fresh alcohol of formula (VIII).

It is also possible to carry out the reaction in a reactor operating continuously, semicontinuously or batchwise. The monoorganoxydiorganosilylpropyl derivative of formula (IX) or the monoorganoxydiorganosilane of formula (XI) is obtained with a molar yield at least equal to 60%, based on the starting reactant of formula (VII) or the starting halosilane of formula (V).

Stage (c) consists in directly reacting the monoorganoxydiorganosilylpropyl derivative of formula (IX) with a metal polysulfide of formula (X).

According to a preferred arrangement, the anhydrous metal polysulfides of formula (X) are prepared by reaction of an alkali metal sulfide, optionally comprising water of crystallization, of formula M₂S (XIII), where the M symbol has the meaning given above (alkali metal), with elemental sulfur, the reaction being carried out at a temperature ranging from 60° C. to 300° C. optionally under pressure and optionally also in the presence of an anhydrous organic solvent.

Advantageously, the alkali metal sulfide M₂S employed is the compound available industrially which is generally in the form of a sulfide hydrate; an alkali metal sulfide of this type which is highly suitable is the sulfide Na₂S available commercially, which is a sulfide hydrate comprising 55 to 65% by weight of NaₛS.

According to a more preferred arrangement for carrying out stage (c), the anhydrous metal polysulfides of formula (X) are prepared beforehand from an alkali metal sulfide M₂S in the form of a sulfide hydrate according to a process which consists in linking together the following operating steps (1) and (2):
step (1), where the alkali metal sulfide hydrate is dehydrated by applying the appropriate method which makes it possible to remove the water of crystallization while retaining the alkali metal sulfide in the solid state throughout the duration of the dehydration step;
step (2), where one mol of dehydrated alkali metal sulfide obtained is subsequently brought into contact with n(x−1) mol of elemental sulfur, the reaction being carried out at a temperature ranging from 20° C. to 120° C. optionally under pressure and optionally also in the presence of an anhydrous organic solvent, the abovementioned factor n lying within the range from 0.8 to 1.2 and the x symbol being as defined above.

With respect to step (1), mention will in particular be made, as dehydration protocol which is highly suitable, of the drying of the alkali metal sulfide hydrate, the operation being carried out under a partial vacuum ranging from 1.33×10² Pa to 40×10² Pa and the compound to be dried being brought to a temperature ranging, at the start of drying, from 70° C. to 85° C. and then the temperature during drying subsequently being gradually raised from the region ranging from 70° C. to 85° C. until the region ranging from 125° C. to 135° C. is reached, a program being followed which provides a first rise in temperature of +10° C. to +15° C. after a first period of time varying from 1 hour to 6 hours, followed by a second rise in temperature of +20° C. to +50° C. after a second period of time varying from 1 hour to 4 hours.

With respect to step (2), mention will be made, as sulfiding protocol which is highly suitable, of the implementation of this reaction in the presence of an anhydrous organic solvent; appropriate solvents are in particular anhydrous lower C₁-C₄ aliphatic alcohols, such as, for example, anhydrous methanol or ethanol.

The number of elemental sulfur atoms Sₓ in the metal polysulfide M₂Sₓ depends on the molar ratio of the S with respect to M₂S; for example, the use of 3 mol of S (n=1 and x−1=3) per mole of M₂S gives the alkali metal tetrasulfide of formula (X) where x=4.

To return to the implementation of stage (c), the latter is carried out within a broad temperature range preferably from 50° C. to 90° C., the reaction preferably also being carried out in the presence of an organic solvent; in this respect, use will advantageously be made of the alcohols referred to above with respect to the implementation of step (2).

The product M-A, and in particular the halide M-Hal, formed during the reaction is generally removed at the end of the stage, for example by filtration.

The bis(monoorganoxydiorganosilylpropyl)polysulfide of formula (I) formed is obtained with a molar yield at least equal to 80%, based on the starting monoorganoxydiorganosilylpropyl derivative of formula (IX).

The following example illustrates the present invention.

### EXAMPLE 1

This example describes the preparation of bis(monoethoxydimethylsilylpropyl)tetrasulfide of formula (III) in which the number x is centered on 4.

The reaction scheme to which this example relates is as follows:

Stage (a):

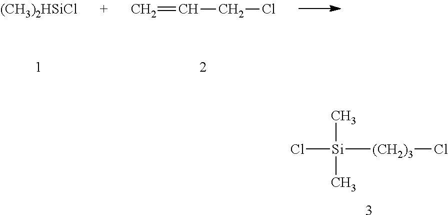

Stage (b):

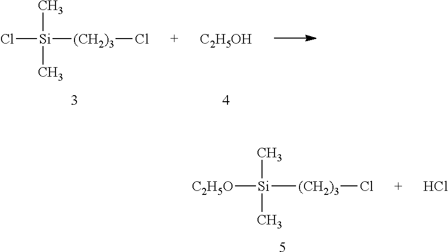

Stage (c):

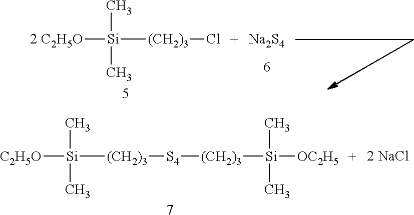

where the reactant 6 is obtained according to equation:

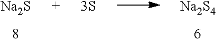

### 1) Stage (a): Synthesis of 3:

165 g of allyl chloride 2 with a purity of 97.5% by weight (2.10 mol) and 0.229 g of catalyst [Ir(COD)Cl]₂, where COD=1,5-cyclooctadiene, are charged to a stirred 1 liter glass reactor equipped with a jacket and with a stirrer and surmounted by a distillation column, and the mixture is stirred in order to completely dissolve the catalyst. The temperature of the mixture is adjusted to 20° C. using the heat-exchange fluid circulating in the jacket.

Dimethylhydrochlorosilane 1, with a purity of 99% by weight, is introduced into the reaction medium via a dip pipe using a pump; 196.5 g (2.06 mol) thereof are introduced over 2 hours 35 minutes. The flow rate for introduction is adjusted in order to maintain the temperature of the reaction medium between 20 and 25° C., taking into account the high exothermicity of the reaction. The reaction medium is kept stirred for 20 minutes after the end of the introduction of the dimethylhydrochlorosilane 1.

At the end of the time for which the reaction medium is kept stirred, a sample is withdrawn for analysis. The results are as follows: degree of conversion of the dimethylhydrochlorosilane 1=99.8% and selectivity for chloropropyldimethylchlorosilane 3=92.7% (by analysis by gas chromatography).

The reaction mixture is subsequently distilled under vacuum (approximately 35×10² Pa) at approximately 40° C. in order to obtain two main fractions: \textcircled{1} light products (residual allyl chloride 2 and traces of residual dimethylhydrochlorosilane 1, essentially accompanied by chloropropyldimethylchlorosilane 3; \textcircled{2} chloropropyldimethylchlorosilane 3, with a molar purity of greater than 98%. A distillation residue composed of heavier products and of catalyst then remains. Molar yield: 85%.

### 2) Stage (b): Synthesis of 5:

304 g of chloropropyldimethylchlorosilane 3, with a molar purity of 98.5%, are charged to a stirred one liter glass reactor equipped with a jacket and surmounted by a condenser with the possibility of reflux. The temperature is brought to 150° C. at atmospheric pressure and a nitrogen flow of 28 g/h is injected at the bottom of the reactor. Reflux at the top of the column is left off line, so as to allow the unreacted alcohol to directly escape, which alcohol can thus be condensed and collected in a flask equipped with a bottom valve. The residual gas stream is directed to an HCl trap (water+sodium hydroxide).

1812 g of ethanol 4 in the anhydrous state, the water content of which is less than 200 ppm (ethanol:silane=22.7:1 (molar)); are injected at the bottom of the reactor using a pump at the rate of 400 g/h. The temperature of the reaction mixture adjusts by itself to the boiling point, which depends on the composition and which changes at the beginning of the running in of the ethanol to rapidly stabilize at approximately 110° C. The time for running in the ethanol is approximately 4 hours 30 minutes. After the ethanol has finished being run in, the mixture is maintained for one hour with flushing with nitrogen. The mixture is subsequently cooled and analyzed.

The following are obtained: a degree of conversion of the chloropropyldimethylchlorosilane 3 of 100% and a selectivity for chloropropyldimethylethoxysilane 5 which exceeds 96%. Molar yield: 96%.

### 3) Stage (c): Synthesis of 7:

3.1) Preparation of Anhydrous Na₂S₄ 6:

Step 1: Drying of Na₂S Hydrate:

43.6 g of industrial Na₂S hydrate flakes comprising approximately 60.5% b_{y} weight of Na₂S are introduced into a 1 liter round-bottomed glass flask of a rotary evaporator. The round-bottomed flask is placed under an argon atmosphere and then under a pressure reduced to 13.3×10² Pa.

The round-bottomed flask is immersed in an oil bath, the temperature of which is then brought to 76° C. This temperature is maintained for 2 hours. Subsequently, a protocol for increasing the temperature of the oil bath is applied in order to avoid melting the Na₂S, which occurs between 85 and 90° C. approximately. The purpose of the gradual increase in the temperature is to accompany the change in the melting point of the product to be dried, which increases when the product dehydrates. The protocol applied is as follows: 1 hour at 82° C., 2 hours at 85° C., 1 hour at 95° C., 1 hour at 115° C. and finally 1 hour at 130° C. It should be noted that this protocol can be modified according to the amount to be dried, the operating pressure and other parameters having an influence on the rate of removal of the water. The amount of water removed, measured by weight difference, is 17.2 g, which corresponds to a moisture content of 39.5% by weight.

Stage (2): Synthesis of Na₂S₄ 6:

The Na₂S (26 g), dried according to the protocol described above, is suspended in 400 ml of ethanol and transferred, by suction, into a stirred jacketed one liter glass reactor equipped with a condenser with a possibility of reflux. 31.9 g of sulfur and 200 ml of anhydrous ethanol are additionally introduced into this reactor. The temperature of the mixture is brought to approximately 80° C. (slight boiling of the ethanol) and the mixture is stirred at 600 rev/min. The mixture is maintained at 80° C. for 2 hours. The solids (Na₂S and the sulfur) gradually disappear and the mixture gradually changes from yellow to orange and then to brown. At the end of the reaction, the mixture is homogeneous at 80° C.: approximately 58 g of anhydrous Na₂S₄ (0.33 mol) in 600 ml of ethanol are available.

3.2) Preparation of 7:

114 g of chloropropyldimethylethoxysilane 5, with a molar purity of 96.6% (i.e. 0.61 mol), are introduced via a dip pipe using a pump into the anhydrous Na₂S₄ in 600 ml of ethanol prepared above maintained at 80° C. (slight boiling of the ethanol) in the reactor in which it was prepared and stirred at 600 rev/min. A sodium chloride precipitate appears. After the chloropropyldimethylethoxysilane 5 has finished being introduced, the mixture is maintained at 80° C. for 2 hours. Subsequently, the mixture is cooled to ambient temperature, withdrawn and then filtered to remove the suspended solids, including the sodium chloride. The filtration cake is washed with ethanol in order to extract as much as possible of the organic products therefrom. The filtrate is reintroduced into the reactor in order to be distilled therein under reduced pressure (approximately 20×10² Pa) for the purpose of removing the ethanol and the possible light products. 114 g of residue, which corresponds to bis(monoethoxydimethylsilylpropyl)tetrasulfide with a quantitatively determined purity of 97% (molar), are recovered.

A yield by weight of bis(monoethoxydimethylsilylpropyl)tetrasulfide of 87% is obtained.

Monitoring by ¹H NMR, by ²⁹Si NMR and by ¹³C NMR makes it possible to confirm that the structure obtained is in accordance with the formula (III) given in the description.

The mean number of S atoms per molecule of formula (III) is equal to 3.9±0.1 (x=3.9±0.1).

### EXAMPLE 2

This example describes a stage (b) in which the alcohol of formula (VIII) used is not anhydrous within the meaning of the present invention.

The operating conditions of Example 1, part 2), were reproduced but starting from ethanol with a water content of the order of 1600 ppm. The following are obtained: a degree of conversion of the chloropropyldimethylchlorosilane 3 of 100% and a selectivity for chloropropyldimethylethoxysilane 5 of approximately 82%. Molar yield of isolated product: 82%.

### EXAMPLE 3

This example describes a stage (b) in which the molar ratio of alcohol of formula (VIII) to silicon compound of formula (VII) is reduced.

The operating conditions of Example 2 were reproduced but with a molar ratio ethanol:silane=15:1 (molar). The following are obtained: a degree of conversion of the chloropropyldimethylchlorosilane 3 of 99% and a selectivity for chloropropyldimethylethoxysilane 5 of approximately 85%. Molar yield of isolated product: 84%.

### EXAMPLE 4

This example describes a stage (b) in which the molar ratio of alcohol of formula (VIII) to silicon compound of formula (VII) is further reduced.

The operating conditions of Example 2 were reproduced but with a molar ratio ethanol:silane=10:1 (molar). The following are obtained: a degree of conversion of the chloropropyldimethylchlorosilane 3 of greater than 97% and a selectivity for chloropropyldimethylethoxysilane 5 of approximately 85%.

### EXAMPLE 5

This example describes a stage (b) in which a portion of the unreacted alcohol is reused in a further batchwise operation.

A portion of the unreacted ethanol is reused in a following test. The operating conditions are those of Example 2 but the ethanol (water content=1600 ppm) is introduced in 3 portions.

The first step corresponds to the introduction of an amount of ethanol, which is recycled from the preceding batchwise operation, until a ratio ethanol:silane=7:1 (molar) is reached. All the ethanol unreacted during this step is collected and discarded.

During the second step, the introduction is continued of the ethanol recycled from the preceding operation until the stock is exhausted, but the unreacted ethanol is retained in order to be recycled during the following operation.

During the third step, fresh ethanol is introduced into the reactor until a total amount introduced corresponding to a ratio ethanol:silane=20:1 (molar) is reached. The ethanol unreacted during this third step is collected in order to be recycled during the following operation.

Such a procedure makes it possible to remove from the system the amount of HCl produced during a batchwise operation: this HCl is present in the unreacted ethanol which was discarded during the first step. The degree of conversion of the chloropropyldimethylchlorosilane is 99%, with a selectivity for the expected product of 88%; the molar yield is 87%.

1-14. (canceled)

15. A process for the preparation of bis(monoorganoxysilylpropyl)polysulfides of formula: 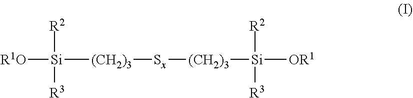
wherein:
the R¹ symbols, which are identical or different, each represent a monovalent hydrocarbonaceous group being a linear alkyl radical having from 1 to 15 carbon atoms, a branched alkyl radical having from 1 to 15 carbon atoms, a linear alkoxyalkyl radical having from 2 to 8 carbon atoms, or a branched alkoxyalkyl radical having from 2 to 8 carbon atoms;
the R² and R³ symbols, which are identical or different, each represent a monovalent hydrocarbonaceous group being a linear alkyl radical having from 1 to 6 carbon atoms, a branched alkyl radical having from 1 to 6 carbon atoms,or a phenyl radical; and
x is an integer or fractional number ranging from 1.5±0.1 to 5±0.1, said process comprising the following steps:
(a) carrying out the following reaction according to the equation: 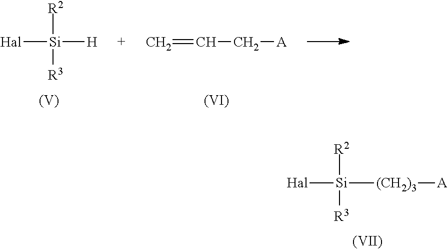
wherein:
the Hal symbol represents a halogen atom being chlorine, bromine or iodine atoms,
the R² and R³ symbols are as defined above,
A represents a removable group being a halogen atom Hal being chlorine, bromine or iodine atoms; or a para-R⁰—C₆H₄—SO₂—O— radical wherein R⁰ is a linear or branched C₁-C₄ alkyl radical; a R⁰—SO₂—O— radical wherein R⁰ is as defined above; or a R⁰—CO—O— radical wherein R⁰ is as defined above,
by reacting, at a temperature ranging from —10° C. to 200° C., one mol of the diorganohalosilane of formula (V) with a stoichiometric molar amount or a molar amount different from stoichiometry of the allyl derivative of formula (VI), the reaction being carried out in a homogeneous or heterogeneous medium in the presence of an initiator which is:
either of a catalytic activator consisting of: (i) at least one catalyst comprising at least one transition metal or one derivative thereof, said metal being by Co, Ru, Rh, Pd, Ir or Pt; and optionally (2i) at least one hydrosilylation reaction promoter, or of a photochemical activator being an ultraviolet radiation or of an ionizing radiation, and, optionally,
by isolating the diorganohalosilylpropyl derivative of formula (VII) formed; then
(b) carrying out the following reaction according to the equation: 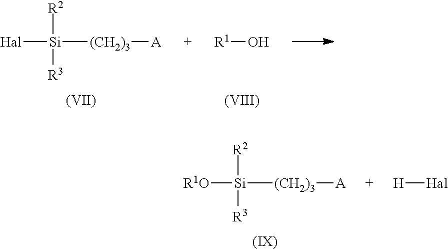
wherein the R¹, R², R³, Hal and A symbols are as defined above,
by reacting, at a temperature ranging from −20° C. to 200° C., either the reaction medium obtained on conclusion of step a) or the diorganohalosilylpropyl derivative of formula (VII), taken in isolation after separation from said medium, with the alcohol of formula (VIII) using at least one mol of alcohol of formula (VIII) per mole of the reactant of formula (VII), the reaction optionally being carried out in the presence of a base or of an organic solvent, and, optionally,
by isolating the monoorganoxydiorganosilylpropyl derivative of formula (IX) formed; then,
(c) carrying out the following reaction according to the equation: 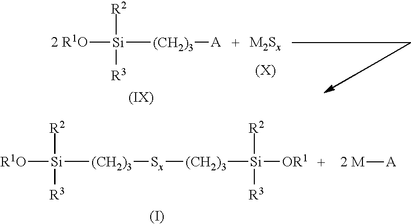
wherein the R¹, R², R³, A and x symbols are as defined above and the M symbol represents an alkali metal,
by reacting, at a temperature ranging from 20° C. to 120° C., either the reaction medium obtained on conclusion of step b) or the monoorganoxydiorganosilylpropyl derivative of formula (IX), taken in isolation after separation from said medium, with the metal polysulfide of formula (X) in the anhydrous state using 0.5±25% mol of metal polysulfide of formula (X) per mole of the reactant of formula (IX), the reaction optionally being carried out in the presence of an inert polar (or nonpolar) organic solvent, and, then
(d) isolating the bis(monoorganoxysilylpropyl) polysulfide of formula (I) formed in step (c).

16. The process as claimed in claim 15, wherein the steps (a) and (b) are replaced with the following steps (a′) and (b′):
step (a′) carrying out the following reaction according to the equation: 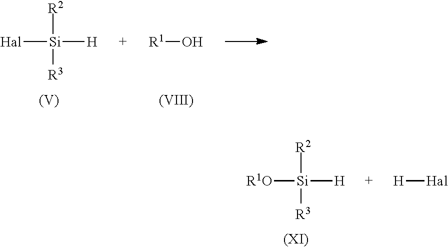
wherein the Hal, R², R³ and R¹ symbols are as defined above, by reacting, at a temperature ranging from −20° C. to 200° C., one mol of the diorganohalosilane of formula (V) with at least one mol of alcohol of formula (VIII), the reaction optionally being carried out in the presence of a base and/or of an organic solvent, and
optionally, by isolating the monoorganoxydiorganosilane of formula (XI) formed;
(b′) carrying out the reaction according to the equation: 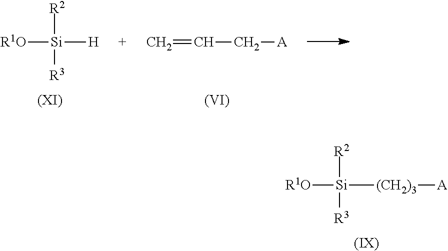
wherein the R¹, R², R³ and A symbols are as defined above,
by reacting either the reaction medium obtained on conclusion of step (a′) or the monoorganoxydiorganosilane of formula (XI), taken in isolation after separation from said medium, using one mol of silane of formula (XI), with a stoichiometric molar amount or a molar amount different from stoichiometry of the allyl derivative of formula (VI), the reaction being carried out in a homogeneous or heterogeneous medium in the presence of an initiator being:
either of a catalytic activator consisting of: (i) at least one catalyst comprising at least one transition metal or one derivative thereof, said metal being Co, Ru, Rh, Pd, Ir or Pt; and optionally (2i) at least one hydrosilylation reaction promoter,
or of a photochemical activator being an ultraviolet radiation or a ionizing radiation, and
optionally, by isolating the monoorganoxydiorganosilylpropyl derivative of formula (IX) formed.

17. The process as claimed in claim 15, wherein the removable group A corresponds to the Hal symbol and represents chlorine, bromine or iodine atoms.

18. The process as claimed in claim 16, wherein the removable group A corresponds to the Hal symbol and represents chlorine, bromine or iodine atoms.

19. The process as claimed in any one of claims 15, wherein step (a) is carried out by operating in the presence of a catalytic activator which comprises, as the catalyst(s) (i), one of the following metal entities selected from the group consisting of: (i-1) a finely divided elemental transition metal; (i-2) a colloid of at least one transition metal; (i-3) an oxide of at least one transition metal; (i-4) a salt derived from at least one transition metal and from an inorganic or carboxylic acid; (i-5) a complex of at least one transition metal equipped with halogenated or organic ligand(s) which optionally have one or more heteroatom(s) or with organosilicon ligand(s); (i-6) a salt as defined above wherein the metal part is equipped with ligand(s) also as defined above; (i-7) a metal entity chosen from the abovementioned entities (elemental transition metal, oxide, salt, complex, complexed salt) wherein the transition metal is combined this time with at least one other metal chosen from the family of the elements from Groups Ib, IIb, IIIa, IIIb, IVa, IVb, Va, Vb, VIb, VIIb and VIII (except Co, Ru, Rh, Pd, Jr and Pt) of the Periodic Table (same reference), said other metal being taken in its elemental form or in a molecular form,; (i-8) a metal entity chosen from the abovementioned entities (elemental transition metal and transition metal-other metal combination; oxide, salt, complex and complexed salt on a transition metal base or on a transition metal-other metal combination base) which is supported on an inert solid support, such as alumina, silica, carbon black, a clay, titanium oxide, an aluminosilicate, a mixture of aluminum and zirconium oxides, or a polymer resin; and (i-9) a supported metal entity corresponding to the definition given above in section (i-8), in the structure of which the inert solid support itself carries at least one halogenated and/or organic ligand which can include one or more heteroatom(s).

20. The process as claimed in any one of claims 16, wherein step (b′) is carried out by operating in the presence of a catalytic activator which comprises, as the catalyst(s) (i), one of the following metal entities selected from the group consisting of: (i-1) a finely divided elemental transition metal; (i-2) a colloid of at least one transition metal; (i-3) an oxide of at least one transition metal; (i-4) a salt derived from at least one transition metal and from an inorganic or carboxylic acid; (i-5) a complex of at least one transition metal equipped with halogenated or organic ligand(s) which optionally have one or more heteroatom(s) or with organosilicon ligand(s); (i-6) a salt as defined above wherein the metal part is equipped with ligand(s) also as defined above; (i-7) a metal entity chosen from the abovementioned entities (elemental transition metal, oxide, salt, complex, complexed salt) wherein the transition metal is combined this time with at least one other metal chosen from the family of the elements from Groups Ib, IIb, Ma, IIIb, IVa, IVb, Va, Vb, VIb, VIIb and VIII (except Co, Ru, Rh, Pd, Ir and Pt) of the Periodic Table (same reference), said other metal being taken in its elemental form or in a molecular form,; (i-8) a metal entity chosen from the abovementioned entities (elemental transition metal and transition metal-other metal combination; oxide, salt, complex and complexed salt on a transition metal base or on a transition metal-other metal combination base) which is supported on an inert solid support, such as alumina, silica, carbon black, a clay, titanium oxide, an aluminosilicate, a mixture of aluminum and zirconium oxides, or a polymer resin; and (i-9) a supported metal entity corresponding to the definition given above in section (i-8), in the structure of which the inert solid support itself carries at least one halogenated and/or organic ligand which can include one or more heteroatom(s).

21. The process as claimed in claim 19, wherein the transition metal of the catalytic activator is Ir or Pt.

22. The process as claimed in claim 20, wherein the transition metal of the catalytic activator is Ir or Pt.

23. The process as claimed in claim 19, wherein the catalytic activator comprises, as the catalyst(s) (i), at least one metal entity of type (i-5) belonging to the iridium complexes of formula:
[Ir(R⁴)Hal]₂ (XII)
wherein:
the R⁴ symbol represents an unsaturated hydrocarbonaceous ligand comprising at least one conjugated or nonconjugated C═C double bond or at least one C≡C triple bond, said ligand being linear or cyclic (mono- or polycyclic), having from 4 to 30 carbon atoms, from 1 to 8 ethylenic or acetylenic unsaturations and optionally comprising one or more heteroatoms; and
the Hal symbol is as defined above.

24. The process as claimed in claim 20, wherein the catalytic activator comprises, as the catalyst(s) (i), at least one metal entity of type (i-5) belonging to the iridium complexes of formula:
[Ir(R⁴)Hal]₂ (XII)
wherein:
the R⁴ symbol represents an unsaturated hydrocarbonaceous ligand comprising at least one conjugated or nonconjugated C═C double bond or at least one C≡C triple bond, said ligand being linear or cyclic (mono- or polycyclic), having from 4 to 30 carbon atoms, from 1 to 8 ethylenic or acetylenic unsaturations and optionally comprising one or more heteroatoms; and
the Hal symbol is as defined above.

25. The process as claimed in claim 15, wherein, at the end of step (a),
when the catalyst has been used in a homogeneous medium, the catalytic metal is recovered in the following way:
step (1): the reaction medium is distilled in order to separate the product formed from a liquid distillation residue comprising the byproducts and the metal of the catalyst or its derivatives,
step (2): the residue is optionally brought into contact with water optionally in the presence of an organic solvent which is inert with respect to H-Hal formed, for the purpose of obtaining an aqueous phase and an organic phase,
step (3): the residue formed in (1) or the residue formed in (2) is brought into contact with an effective amount of solid substance which adsorbs the metal of the catalyst, and
step (4): the adsorbent is separated from the catalytic metal for the purpose of recovering said metal.

26. The process as claimed in claim 16, wherein, at the end of step (b′), when the catalyst has been used in a homogeneous medium, the catalytic metal is recovered in the following way:
step (1): the reaction medium is distilled in order to separate the product formed from a liquid distillation residue comprising the byproducts and the metal of the catalyst or its derivatives,
step (2): the residue is optionally brought into contact with water optionally in the presence of an organic solvent which is inert with respect to H-Hal formed, for the purpose of obtaining an aqueous phase and an organic phase,
step (3): the residue formed in (1) or the residue formed in (2) is brought into contact with an effective amount of solid substance which adsorbs the metal of the catalyst, and
step (4): the adsorbent is separated from the catalytic metal for the purpose of recovering said metal.

27. The process as claimed in claim 15, wherein step (b) is carried out in the absence of a nonaqueous base or of an organic base and by promoting the removal of the halogen acid formed from the reaction medium by carrying out the following steps:
1k: degassing the halogen acid by heating the reaction medium at its boiling point,
2k: stripping the halogen acid using a dry inert gas, and
3k: degassing by using an appropriate partial vacuum, or
4k: removing the halogen acid formed by entrainment using an organic solvent.

28. The process as claimed in claim 16, wherein step (a′) is carried out in the absence of a nonaqueous base or of an organic base and by promoting the removal of the halogen acid formed from the reaction medium by carrying out the following steps:
1k: degassing the halogen acid by heating the reaction medium at its boiling point,
2k: stripping the halogen acid using a dry inert gas, and
3k: degassing by using an appropriate partial vacuum, or
4k: removing the halogen acid formed by entrainment using an organic solvent.

29. The process as claimed in claim 15, wherein step (b) is carried out further using an alcohol of formula (VIII) with a water content of less than 1000 ppm.

30. The process as claimed in claim 16, wherein step (a′) is carried out further using an alcohol of formula (VIII) with a water content of less than 1000 ppm.

31. The process as claimed in claim 28, wherein step (b) is carried out in the absence of a base, at a temperature lying within the range from 60° C. to 160° C., using anhydrous alcohol having less than 1000 ppm of water and removing the halogen acid by application of step 4k, the molar ratio of alcohol of formula (VIII) to silicon compound of formula (VII) or silane of formula (V) lying within the range from 3 to 23.

32. The process as claimed in claim 29, wherein step (a′) is carried out in the absence of a base, at a temperature lying within the range from 60° C. to 160° C., using anhydrous alcohol having less than 1000 ppm of water and removing the halogen acid by application of step 4k, the molar ratio of alcohol of formula (VIII) to silicon compound of formula (VII) or silane of formula (V) lying within the range from 3 to 23.

33. The process as claimed in claim 15, wherein step (b) is carried out using, as starting alcohol of formula (VIII), an alcohol reactant consisting in all or part of the distilled mixture based on alcohol of formula (VIII) and on halogen acid resulting from the batchwise implementation of a preceding operation, with optional supplementary addition of fresh alcohol of formula (VIII).

34. The process as claimed in claim 16, wherein step (a′) is carried out using, as starting alcohol of formula (VIII), an alcohol reactant consisting in all or part of the distilled mixture based on alcohol of formula (VIII) and on halogen acid resulting from the batchwise implementation of a preceding operation, with optional supplementary addition of fresh alcohol of formula (VIII).

35. The process as claimed in claim 15, wherein step (c) is carried out using anhydrous metal polysulfides of formula (X) which are prepared beforehand from an alkali metal sulfide M₂S in the form of a sulfide hydrate according to a process which consists in linking together the following operating steps (1) and (2):
(1), the alkali metal sulfide hydrate is dehydrated by applying the appropriate method which makes it possible to remove the water of crystallization while retaining the alkali metal sulfide in the solid state throughout the duration of the dehydration step; and
step (2), one mol of dehydrated alkali metal sulfide obtained is subsequently brought into contact with n(x−1) mol of elemental sulfur, the reaction being carried out at a temperature ranging from 20° C. to 120° C. optionally under pressure and optionally also in the presence of an anhydrous organic solvent, the abovementioned factor n lying within the range from 0.8 to 1.2 and the x symbol being as defined above.

36. The process as claimed in claim 16, wherein step (c) is carried out using anhydrous metal polysulfides of formula (X) which are prepared beforehand from an alkali metal sulfide M₂S in the form of a sulfide hydrate according to a process which consists in linking together the following operating steps (1) and (2):
(1), the alkali metal sulfide hydrate is dehydrated by applying the appropriate method which makes it possible to remove the water of crystallization while retaining the alkali metal sulfide in the solid state throughout the duration of the dehydration step; and
step (2), one mol of dehydrated alkali metal sulfide obtained is subsequently brought into contact with n(x−1) mol of elemental sulfur, the reaction being carried out at a temperature ranging from 20° C. to 120° C. optionally under pressure and optionally also in the presence of an anhydrous organic solvent, the abovementioned factor n lying within the range from 0.8, to 1.2 and the x symbol being as defined above.
